(19) United States
(12) Patent Application Publication
(10) Pub. No.: US 2026/0059578 A1
(43) Pub. Date: Feb. 26, 2026

(54) METHODS, DEVICES, AND COMPUTER READABLE MEDIUM FOR COMMUNICATION

(71) Applicant: NEC Corporation, Tokyo (JP)

(72) Inventors: Lin LIANG, Beijing (CN); Gang WANG, Beijing (CN)

(73) Assignee: NEC Corporation, Tokyo (JP)

(21) Appl. No.: 19/103,672

(22) PCT Filed: Aug. 29, 2022
(86) PCT No.: PCT/CN2022/115576

§ 371 Date: Feb. 13, 2025

(51) Int. Cl. H04W 74/0833; H04L 5/00; H04W 72/232

(52) U.S. Cl. CPC H04W 74/0833; H04L 5/0055; H04W 72/232

(57) ABSTRACT

Embodiments of the present disclosure relate to methods, devices, and computer readable medium for communication. According to embodiments of the present disclosure, a terminal device transmits, a random access preamble in one or more of a plurality of random access occasions to a network device. The terminal device starts a random access response window at a first monitoring occasion from an end of a last transmission of the random access preamble. During the random access response window, the terminal device monitors for a random access response message based on a random access-radio network temporary identifier (RA-RNTI) associated with the last transmission of the random access preamble. In this way, it can give more processing time for network response.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. In order to improve coverage of a cell, repetition has been introduced. For example, to improve coverage of physical random access channel (PRACH), repetition of PRACH is introduced. After transmission of PRACH preamble, user equipment (UE) may start a random access response (RAR) window to monitor RAR by downlink control information (DCI) scrambled by radio access-radio network temporary identifier (RA-RNTI) where RA-RNTI is determined based on the time and frequency resources of the PRACH transmission. It is worth studying on how to combine repetition of PRACH and other techniques.

### SUMMARY

In general, example embodiments of the present disclosure provide a solution for communication.

In a first aspect, there is provided a method for communication. The method comprises transmitting, at a terminal device and to a network device, a random access preamble in one or more of a plurality of random access occasions; starting a random access response window at a first monitoring occasion from an end of a last transmission of the random access preamble; and during the random access response window, monitoring for a random access response message based on a random access-radio network temporary identifier (RA-RNTI) associated with the last transmission of the random access preamble.

In a second aspect, there is provided a method for communication. The method comprises transmitting, at a terminal device and to a network device, a random access preamble in one or more of a plurality of random access occasions; starting a random access response window at a first monitoring occasion from an end of a configured random access occasion in the one or more random access occasions; and during the random access response window, monitoring for a random access response message based on a random access-radio network temporary identifier (RA-RNTI).

In a third aspect, there is provided a method for communication. The method comprises transmitting, at a terminal device and to a network device, a random access preamble; receiving, from the network device, first downlink control information (DCI) scrambled with a random access-radio network temporary identifier (RA-RNTI) in a random access response window, wherein the first DCI comprises a first indication and schedules a first data transmission on a physical downlink shared channel (PDSCH); receiving, from the network device, second DCI scrambled with the RA-RNTI in the random access response window, wherein the second DCI comprises a second indication and schedules a second data transmission on the PDSCH; and in accordance with a determination that the first and second indications are same, combining the first data transmission and the second data transmission.

In a fourth aspect, there is provided a method for communication. The method comprises receiving, at a terminal device and from a network device, a configuration indicating an uplink resource for a feedback of a random access response on a physical downlink shared channel (PDSCH); receiving, from the network device, downlink control information which is scrambled with a random access-radio network temporary identifier (RA-RNTI) and schedules the PDSCH; receiving, from the network device, the random access response on the PDSCH; and in accordance with a determination that the terminal device fails to decode the random access response, transmitting, to the network device, a non-acknowledgment (NACK) on the uplink resource.

In a fifth aspect, there is provided a method for communication. The method comprises transmitting, at a network device and to a terminal device, a configuration indicating an uplink resource for a feedback of a random access response on a physical downlink shared channel (PDSCH); transmitting, to the terminal device, downlink control information which is scrambled with a random access-radio network temporary identifier (RA-RNTI) and schedules the PDSCH; transmitting, to the terminal device, the random access response on the PDSCH; and in accordance with a determination that the terminal device fails to decode the random access response, receiving, from the terminal device, a non-acknowledgment (NACK) on the uplink resource.

In a sixth aspect, there is provided a terminal device. The terminal device comprises a processing unit; and a memory coupled to the processing unit and storing instructions thereon, the instructions, when executed by the processing unit, causing the terminal device to perform acts comprising: transmitting, to a network device, a random access preamble in one or more of a plurality of random access occasions; starting a random access response window at a first monitoring occasion from an end of a last transmission of the random access preamble; and during the random access response window, monitoring for a random access response message based on a random access-radio network temporary identifier (RA-RNTI) associated with the last transmission of the random access preamble.

In a seventh aspect, there is provided a terminal device. The terminal device comprises a processing unit; and a memory coupled to the processing unit and storing instructions thereon, the instructions, when executed by the processing unit, causing the terminal device to perform acts comprising: transmitting, to a network device, a random access preamble in one or more of a plurality of random access occasions; starting a random access response window at a first monitoring occasion from an end of a configured random access occasion in the one or more random access occasions; and during the random access response window, monitoring for a random access response message based on a random access-radio network temporary identifier (RA-RNTI).

In an eighth aspect, there is provided a terminal device. The terminal device comprises a processing unit; and a memory coupled to the processing unit and storing instructions thereon, the instructions, when executed by the processing unit, causing the terminal device to perform acts comprising: transmitting, at a terminal device and to a network device, a random access preamble; receiving, from the network device, first downlink control information (DCI) scrambled with a random access-radio network temporary identifier (RA-RNTI) in a random access response window, wherein the first DCI comprises a first indication and schedules a first data transmission on a physical downlink shared channel (PDSCH); receiving, from the network device, second DCI scrambled with the RA-RNTI in the random access response window, wherein the second DCI comprises a second indication and schedules a second data transmission on the PDSCH; and in accordance with a determination that the first and second indications are same, combining the first data transmission and the second data transmission.

In a ninth aspect, there is provided a terminal device. The terminal device comprises a processing unit; and a memory coupled to the processing unit and storing instructions thereon, the instructions, when executed by the processing unit, causing the terminal device to perform acts comprising: receiving, at a terminal device and from a network device, a configuration indicating an uplink resource for a feedback of a random access response on a physical downlink shared channel (PDSCH); receiving, from the network device, downlink control information which is scrambled with a random access-radio network temporary identifier (RA-RNTI) and schedules the PDSCH; receiving, from the network device, the random access response the PDSCH; and in accordance with a determination that the terminal device fails to decode the random access response, transmitting, to the network device, a non-acknowledgment (NACK) on the uplink resource.

In a tenth aspect, there is provided a network device. The network device comprises a processing unit; and a memory coupled to the processing unit and storing instructions thereon, the instructions, when executed by the processing unit, causing the network device to transmitting, to a terminal device, a configuration indicating an uplink resource for a feedback of a data transmission on a physical downlink shared channel (PDSCH); transmitting, to the terminal device, downlink control information which is scrambled with a random access-radio network temporary identifier (RA-RNTI) and schedules the PDSCH; transmitting, to the terminal device, the random access response on the PDSCH; and in accordance with a determination that the terminal device fails to decode the random access response on the PDSCH, receiving, from the terminal device, a non-acknowledgment (NACK) on the uplink resource.

In an eleventh aspect, there is provided a computer readable medium having instructions stored thereon, the instructions, when executed on at least one processor, causing the at least one processor to carry out the method according to the first, second, third, fourth or fifth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 shows a schematic diagram of a random access response window according to some embodiments of the present disclosure;

FIGS. 4A and 4B show schematic diagrams of random access response (RAR) windows according to some embodiments of the present disclosure, respectively;

FIG. 5 illustrates a signaling flow for communications according to some embodiments of the present disclosure;

FIG. 6 shows a schematic diagram of combining physical downlink shared channels (PDSCHs) according to some embodiments of the present disclosure;

FIG. 7 illustrates a signaling flow for communications according to some embodiments of the present disclosure;

FIG. 8 is a flowchart of an example method in accordance with an embodiment of the present disclosure;

FIG. 9 is a flowchart of an example method in accordance with an embodiment of the present disclosure;

FIG. 10 is a flowchart of an example method in accordance with an embodiment of the present disclosure;

FIG. 11 is a flowchart of an example method in accordance with an embodiment of the present disclosure;

FIG. 12 is a flowchart of an example method in accordance with an embodiment of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25GHz to 71GHz), frequency band larger than 100GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “random access occasion” used herein can refer to a time domain and frequency domain resource for transmitting a random access preamble. The term “random access occasion” and the term “physical random access channel (PRACH) occasion” can be used interchangeable. The term “scramble with X”used herein may refer to code based on X.

As mentioned above, to improve coverage of physical random access channel (PRACH), repetition of PRACH is introduced. After transmission of PRACH preamble, user equipment (UE) may start a random access response (RAR) window to monitor RAR by downlink control information (DCI) scrambled by radio access-radio network temporary identifier (RA-RNTI) where RA-RNTI is determined based on the time and frequency resources of the PRACH transmission. However, when PRACH repetition is adopted, how to start a corresponding RAR window and determine the RA-RNTI are not clear.

Embodiments of the present disclosure provide a solution on RAR window and RA-RNTI are proposed. According to embodiments of the present disclosure, a terminal device transmits a random access preamble in one or more of a plurality of random access occasions to a network device. The terminal device starts a random access response window at a first monitoring occasion from an end of a last transmission of the random access preamble. During the random access response window, the terminal device monitors for a random access response message based on a random access-radio network temporary identifier (RA-RNTI) associated with the last transmission of the random access preamble. In this way, it can give more processing time for network response.

Principles and implementations of the present disclosure will be described in detail below with reference to the figures.

### Example of Communication Network

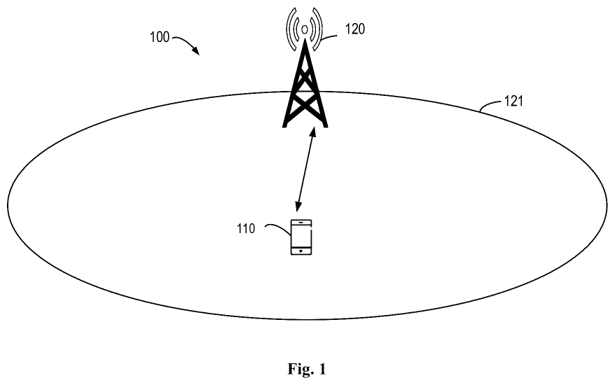

FIG. 1 illustrates a schematic diagram of an example communication network 100 in which some embodiments of the present disclosure can be implemented. As shown in FIG. 1, the communication network 100 may include a terminal device 110 and a network device 120. The network device 120 may provide a cell 121 to serve one or more terminal devices. In this example, the terminal device 110 is located in the cell 121 and is served by the network device 120.

It is to be understood that the number of devices and cells in FIG. 1 is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “slot” used herein refers to a dynamic scheduling unit. One slot comprises a predetermined number of symbols. The slot used herein may refer to a normal slot which comprises a predetermined number of symbols and also refer to a sub-slot which comprises fewer symbols than the predetermined number of symbols.

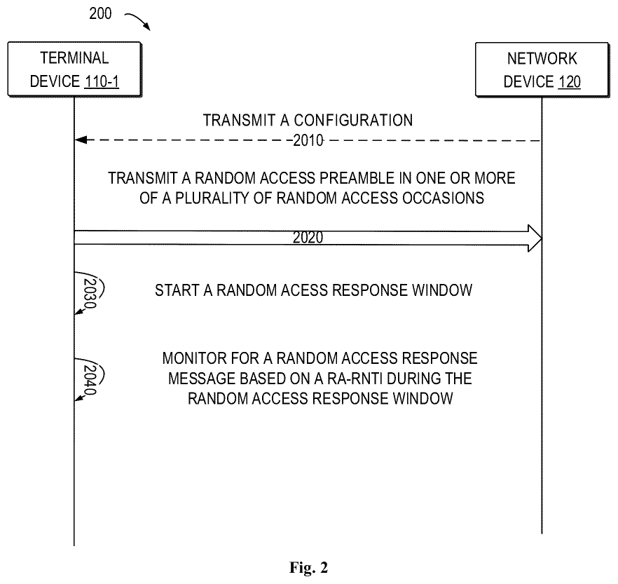

Embodiments of the present disclosure will be described in detail below. Reference is first made to FIG. 2, which shows a signaling chart illustrating process 200 among the terminal device and the network device according to some example embodiments of the present disclosure. Only for the purpose of discussion, the process 200 will be described with reference to FIG. 1. For example, the process 200 may involve the terminal device 110 and the network device 120.

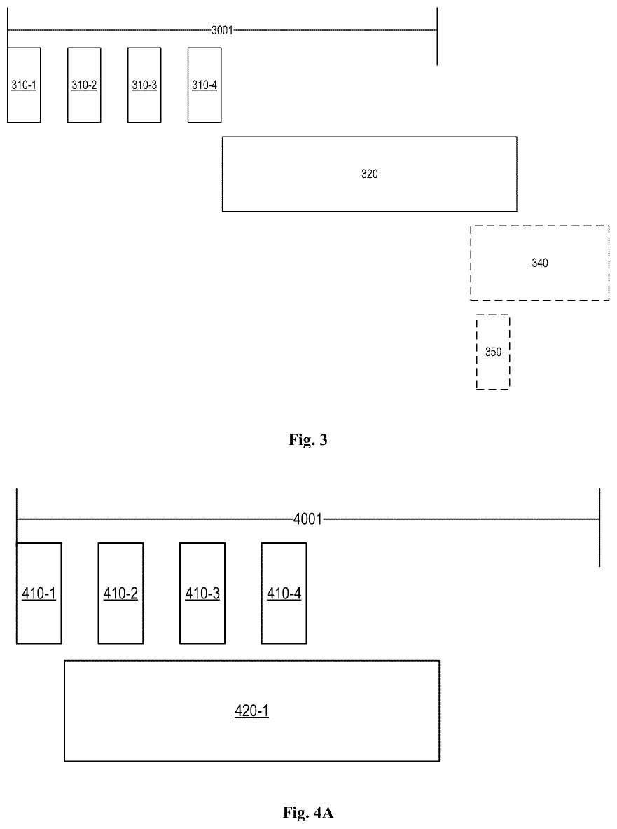

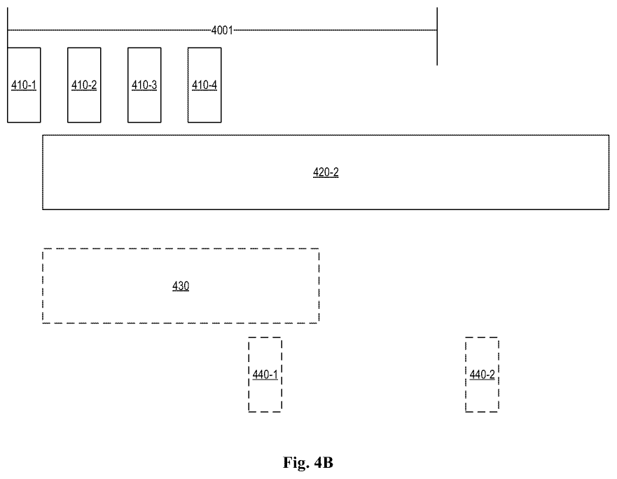

The network device 120 may transmit 2010 a configuration to the terminal device 110. The configuration may indicate a set random access occasions in which a random access preamble for a random access can be transmitted. In addition, the configuration may also indicate a set of random access preambles. For example, the network device 120 may broadcast system information including the configuration. By way of example, as shown in FIG. 3, the configuration may indicate the random access occasions 310-1, 310-2, 310-3 and 310-4. As another example, as shown in FIGS. 4A and 4B, the configuration may indicate the random access occasion 410-1, 410-2, 410-3 and 410-4. It is noted that the numbers of random access occasions shown in FIGS. 3-4B are only examples not limitation.

In some embodiments, the terminal device 110 may select a random access preamble from the set of random access preambles. For example, the terminal device 110 may randomly select the random access preamble. In some embodiments, the random access preamble may include a plurality of PRACH preamble sequences.

The terminal device 110 transmits 2020 the random access preamble in one or more of the set of random access occasions. In other words, the terminal device 110 may perform the repetition of the random access preamble. By way of example, as shown in FIG. 3, the terminal device 110 may transmit the random access preamble in one or more of the random access occasions 310-1, 310-2, 310-3 and 310-4. As another example, as shown in FIGS. 4A and 4B, the terminal device 110 may transmit the random access preamble in one or more of the random access occasion 410-1, 410-2, 410-3 and 410-4.

The terminal device 110 starts 2030 a random access response (RAR) window at a first monitoring occasion from an end of a configured random access occasion in the one or more random access occasions. In some embodiments, the configured random access occasion may be the last random access occasion in the one or more random access occasion. In some other embodiments, the configured random access occasion may be the first random access occasion in the one or more random access occasion. Alternatively, the terminal device may determine the configured random access occasion based on the number of transmissions of the random access preamble.

During the RAR window, the terminal device 110 monitors 2040 for a random access response message based on a random access-radio network temporary identifier (RA-RNTI) associated with the configured random access occasion. For example, in some embodiments, if the terminal device 110 starts the RAR window at a first monitoring occasion from an end of a last transmission of the random access preamble, the terminal device 110 may monitor for a random access response message based on the RA-RNTI associated with the last transmission of the random access preamble. In this case, the terminal device 110 may determine the RA-RNTI based on a first index of a first symbol of the last transmission of the random access preamble, and a second index of a first slot of the last transmission of the random access preamble in a system frame. By way of example, the RA-RNTI associated with the random access occasion in which the random access preamble is transmitted, may be determined as: RA-RNTI=1+s_id+14×t_id+14×80×f_id+14×80×8×ul_carrier_id, where s_id represents the index of the first OFDM symbol of the last transmission of the random access preamble (0≤s_id<14), t_id represents the index of the first slot of the last transmission of the random access preamble in a system frame (0≤t_id<80), f_id represents the index of the random access occasion where the last transmission of the random access preamble occurs in the frequency domain (0≤f_id<8), and ul_carrier_id represents the UL carrier used for Random Access Preamble transmission (0 for NUL carrier, and 1 for SUL carrier).

Alternatively, in some embodiments, if the terminal device 110 starts the RAR window at a first monitoring occasion from an end of a first transmission of the random access preamble, the terminal device 110 may monitor for a random access response message based on the RA-RNTI associated with the first transmission of the random access preamble. In this case, in some embodiments, the terminal device 110 may determine the RA-RNTI based on a first index of a first symbol of the first random access occasion, and a second index of a first slot of the first random access occasion in a system frame. In addition, in some embodiments, a length of the RAR window exceeds a threshold length. For example, the length of the RAR window may be longer than 10 ms. In some embodiments, the network device 120 may transmit downlink control information that includes an indication for stopping the monitoring of the RAR message to the terminal device 110. By way of example, the RA-RNTI associated with the random access occasion in which the random access preamble is transmitted, may be determined as: RA-RNTI=1+s_id+14×t_id+14×80×f_id+14×80×8×ul_carrier_id, where s_id represents the index of the first OFDM symbol of the first transmission of the random access preamble (0≤s_id<14), t_id represents the index of the first slot of the first transmission of the random access preamble in a system frame (0≤t_id<80), f_id represents the index of the random access occasion where the first transmission of the random access preamble occurs in the frequency domain (0≤f_id<8), and ul_carrier_id represents the UL carrier used for Random Access Preamble transmission (0 for NUL carrier, and 1 for SUL carrier).

In some embodiments, the terminal device 110 may detect a DCI format scrambled by the RA-RNTI. The terminal device 110 may determine a first set of least significant bits (LSBs) of a first system frame number (SFN) in the DCI format are same as a second set of LSBs of a second SFN where a last transmission of the random access preamble is performed. The terminal device 110 may also receive a transport block on a physical downlink shared channel (PDSCH) within the random access response window and may transmit the transport block to a layer which is higher than a physical layer of the terminal device. In other words, if the UE detects the DCI format 1_0 with cyclic redundancy check (CRC) scrambled by the corresponding RA-RNTI, LSBs of a SFN field in the DCI format 1_0 (if included and applicable), are same as corresponding LSBs of the SFN where the UE transmitted the last PRACH repetition, and the UE receives a transport block in a corresponding PDSCH within the window, the UE may pass the transport block to higher layers. In this way, when RAR window is longer than 10 ms, LSBs of SFN field may be used to determine on which random access occasion network responses in the RAR message. For PRACH repetition, the first PRACH repetition and the last repetition may locate at different system frame with different SFN, and the gap between the first PRACH repetition and the last repetition may be larger than a frame if large number of repetition and less RO in a frame is configured by network. Since the RAR window starting immediately from the end of the last PRACH repetition, LSBs of a SFN determined based on the last PRACH repetition can have a unique and deterministic PRACH occasion. If LSBs of a SFN is determined based on the first PRACH repetition, different RO on different system frame between PRACH repetition and legacy PRACH will map the same LSBs of a SFN when the first PRACH repetition and the last repetition locates at different system frame.

Alternatively, in some embodiments, the terminal device 110 may detect a DCI format scrambled by the RA-RNTI. The terminal device 110 may determine a first set of least significant bits (LSBs) of a first system frame number (SFN) in the DCI format are same as a second set of LSBs of a second SFN where a first transmission of the random access preamble is performed. The terminal device 110 may also receive a transport block on a physical downlink shared channel (PDSCH) within the random access response window and may transmit the transport block to a layer which is higher than a physical layer of the terminal device. In this case, the terminal device 110 may determine the RA-RNTI based on the first transmission of the random access preamble. In other words, if the UE detects the DCI format 1_0 with CRC scrambled by the corresponding RA-RNTI and LSBs of a SFN field in the DCI format 1_0, if included and applicable, are same as corresponding LSBs of the SFN where the UE transmitted the first PRACH repetition, and the UE receives a transport block in a corresponding PDSCH within the window, the UE may pass the transport block to higher layers. The corresponding RA-RNTI may be determined by the first preamble repetition transmission. In this way, if the first PRACH repetition is used to determine the RA-RNTI, similar LSBs of the SFN determination as RA-RNTI can have a unified implementation which has benefits.

Embodiments are described with reference to FIG. 3. As shown in FIG. 3, the terminal device 110 may perform the random access preamble repetitions in the random access occasions 310-1, 310-2, 310-3 and 310-4. FIG. 3 also shows a 10 ms frame 3001. After the random access preamble repetition is transmitted and regardless of the possible occurrence of a measurement gap, the medium access control (MAC) entity of the terminal device 110 may start the ra-ResponseWindow 320 configured in RACH-ConfigCommon at the first PDCCH occasion from the end of the last preamble repetition transmission 310-4. The MAC entity of the terminal device 110 may monitor the PDCCH of the secondary primary cell (SpCell) for RAR(s) identified by the RA-RNTI while the ra-ResponseWindow 320 is running. The RA-RNTI may be determined based on the index of the first OFDM symbol of the last preamble repetition transmission, and the index of the first slot of the last preamble repetition transmission in a system frame. In this way, starting RAR window from the end of last PRACH repetition can give more processing time for network response. In addition, usually the RAR window length may be less than 10 ms in which unique RA-RNTI is applied.

Moreover, as shown in FIG. 3, if RA-RNTI is determined by the first preamble repetition, a DCI 350 scrambled by RA-RNTI may not be distinguished between PRACH repetition RAR and legacy RAR 340 due to monitoring the same RA-RNTI on the overlapped RAR window. It may happen when RAR window starts from the end of last PRACH repetition. It means there may be two different PRACH occasion mapping to one RAR. If it is allowed, additional procedure to determine on which PRACH transmission occasion where RAR is provided by this RAR needs be applied, which may have impact on implementation. According to embodiments shown in FIG. 3, if the last PRACH repetition occasion is used to determine RA-RNTI, then the corresponding PRACH occasion indicated by RAR in the RAR window may be unique and deterministic.

Embodiments are described with reference to FIGS. 4A and 4B. As shown in FIGS. 4A and 4B, the terminal device 110 may perform the random access preamble repetitions in the random access occasions 410-1, 410-2, 410-3 and 410-4. FIGS. 4A and 4B also show a 10 ms frame 4001. After the random access preamble repetition is transmitted and regardless of the possible occurrence of a measurement gap, the medium access control (MAC) entity of the terminal device 110 may start the ra-ResponseWindow 420-1 configured in RACH-ConfigCommon at the first PDCCH occasion from the end of the first preamble repetition transmission. The MAC entity of the terminal device 110 may monitor the PDCCH of the SpCell for RAR identified by the RA-RNTI while the ra-ResponseWindow 420-1 is running. In this case, in some embodiments, the RA-RNTI may be determined based on the index of the first OFDM symbol of the first preamble repetition transmission, and the index of the first slot of the first preamble repetition transmission in a system frame. Alternatively, as shown in FIG. 4B, a longer RAR window 420-2 may be configured. For example, the RAR window 420-2 may be longer than 10 ms. In this way, starting RAR window from the end of the first PRACH repetition can give flexibility of early PRACH detection from network perspective and reduce PRACH access latency when network can early detect out the PRACH transmission.

In some embodiments, a bit field in DCI may be used to help early stop RAR monitoring. For example, a group of preambles and corresponding indication bit may be configured in DCI. By way of example, if the bit is ‘1’in the DCI, the terminal device 110 may assume network response all preamble ID(s) detected by network in the corresponding occasions in this RAR. If the terminal device 110 doesn't detects the preamble ID which is transmitted by itself, the terminal device 110 may stop RAR monitoring and try the next PRACH re-transmission immediately. In this way, the terminal device could early stop monitoring and start the next PRACH re-transmission immediately which could reduce access latency. For example, as shown in FIG. 4B, when longer RAR window 420-2 is configured, if a DCI 440-1 scrambled by corresponding RA-RNTI is detected in the RAR window 430 but the corresponding preamble ID is not detected, the UE may continue to monitor DCI until the end of RAR window. Network may only response legacy PRACH RAR in the first DCI 440-1 and response repetition PRACH RAR in the second DCI 440-2. However, network may also response both legacy PRACH RAR and repetition PRACH RAR together in the first DCI 440-1. UE cannot assume network behavior and has to wait till the end of RAR window. In this case, if an indication of network is provided by network, UE could early stop monitoring and start the next PRACH re-transmission immediately which could reduce access latency.

In some embodiments, after the random access preamble repetition is transmitted and regardless of the possible occurrence of a measurement gap, the medium access control (MAC) entity of the terminal device 110 may start the ra-ResponseWindow configured in RACH-ConfigCommon at the first PDCCH occasion from the end of the configured preamble transmission occasion. In this case, the configured preamble transmission occasion may be determined based on the number of PRACH repetition. In this way, when the PRACH repetition number is small, starting RAR window from the end of repetition is benefit on power combination. Moreover, network may configure different number of PRACH repetition to different channel conditions. Hence, flexible RAR starting window based on different number of PRACH repetition can achieve both benefits and give enough flexibility for network scheduling.

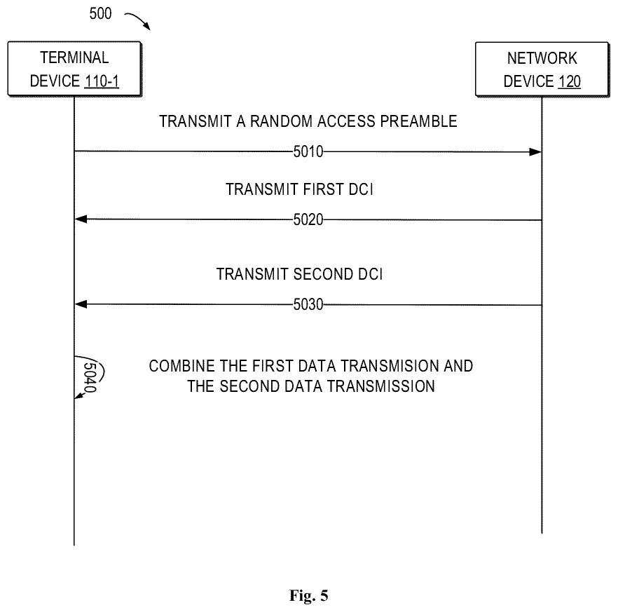

Reference is first made to FIG. 5, which shows a signaling chart illustrating process 500 among the terminal device and the network device according to some example embodiments of the present disclosure. Only for the purpose of discussion, the process 500 will be described with reference to FIG. 1. For example, the process 500 may involve the terminal device 110 and the network device 120.

The terminal device 110 transmits 2010 a random access preamble to the network 120. In some embodiments, the terminal device 110 may perform a repetition of the random access preamble.

The network device 120 transmits 5020 first DCI to the terminal device 110 in a random access response window. The first DCI is scrambled with a RA-RNTI and comprises a first indication and schedules a first data transmission on a physical downlink shared channel (PDSCH) which can be referred to as a first PDSCH.

3 schedules a second data transmission on a physical downlink shared channel (PDSCH) which can be referred to as a second PDSCH. If the first and second indications are same, the terminal device 110 combines 5040 the first data transmission and the second data transmission. In other wors, there may be indication in DCI (for example, one or more bit field(s)) to indicate the MAC protocol data unit (PDU) of the PDSCH scheduled by this DCI is the same as that scheduled by another DCI in the RAR window, if RA-RNTI and the indication in the two DCI(s) are the same. The terminal device 110 may soft combine the PDSCH scheduled by the two DCIs. In this way, there are reserved field in DCI format 1_0 scramble by RA-RNTI. Using DCI field instead of RA-RNTI can save RNTI values. DCI can configure more than one bit, which implies network can group preamble(s) transmitted in RAR. To further increase coverage, network may transmit response of detected preamble in multiple RAR that each RAR could have less bits. To support repetition of plenty of each RAR(s) of the same RA-RNTI, bits value in DCI could indicate such group of preambles and same bits value (other than 0) can map to one group of preambles transmitted in RAR.

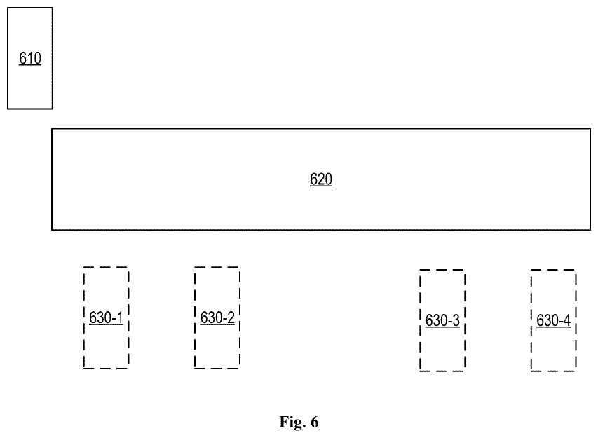

By way of example, as shown in FIG. 6, the terminal device 110 may transmit the random access preamble in the random access occasion 610. After the transmission of the random access preamble, the terminal device 110 may start the RAR window 620. During the RAR window 620, the terminal device 110 may receive the DCI 630-1 scrambled by the RA-RNIT which contains preamble ID 0-19 and an indication “01”. The terminal device 110 may also receive the DCI 630-2 scrambled by the RA-RNIT which contains preamble ID 20-39 and an indication “10”. The terminal device 110 may also receive the DCI 630-3 scrambled by the RA-RNIT which an indication “01”. The terminal device 110 may also receive the DCI 630-4 scrambled by the RA-RNIT which contains an indication “10”. In this case, since the indications included in the DCIs 630-1 and 630-3 are the same, the terminal device 110 may combine the data transmissions on PDSCH scheduled by the DCIs 630-1 and 630-3. The terminal device 110 may also combine the data transmissions on PDSCH scheduled by the DCIs 630-2 and 630-3.

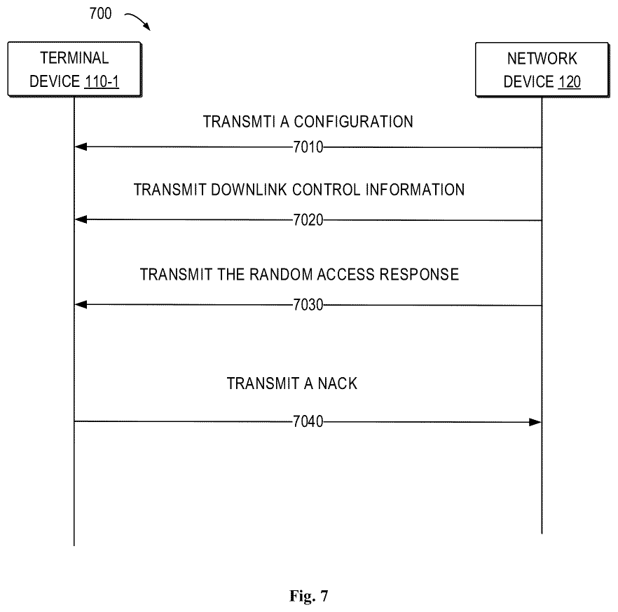

Reference is first made to FIG. 7, which shows a signaling chart illustrating process 700 among the terminal device and the network device according to some example embodiments of the present disclosure. Only for the purpose of discussion, the process 700 will be described with reference to FIG. 1. For example, the process 700 may involve the terminal device 110 and the network device 120.

The network device 120 transmits 7010, to the terminal device 110, a configuration indicating an uplink resource for a feedback of a random access response on a physical downlink shared channel (PDSCH) associated with a random access response. The network device 120 transmits 7020 downlink control information to the terminal device 110. The downlink control information is scrambled with a RA-RNTI and schedules the PDSCH. The network device 120 further transmits 7030 the random access response to the terminal device 110. The terminal device 110 may decode the random access response. In this case, if the terminal device 110 fails to decode the random access response the PDSCH, the terminal device 110 transmits 7040 a non-acknowledgment (NACK) to the network device on the uplink resource. In other words, NACK only PUCCH resources may be configured for PDSCH of RAR. If UE detects DCI scramble by the corresponding RA-RNTI but PDSCH is not decoded right, UE could feedback NACK on the configured PUCCH. In this way, network can re-transmit RAR message based on feedback instead of blind re-transmission, which can save system workload when all initial RAR message are decoded right by UE. Network may configure dedicates PUCCH resources to dedicated set of preambles. Moreover, based on the PUCCH resources receiving NACK, network can determine which set of preambles are missing and re-schedule the RAR re-transmission to reduce the payload (e.g. exclude the preamble ID in RAR that doesn't feedback NACK).

In some embodiments, a time length between a first slot in which the downlink control information is received and a second slot in which the NACK is transmitted may be pre-determined or configured. In other words, the timing between slot containing RAR DCI and slot containing NACK feedback may be pre-determined or configured. In some embodiments, a time length between a first slot in which the PDSCH containing RAR is received and a second slot in which the NACK is transmitted may be pre-determined or configured. In other words, the timing between slot containing RAR PDSCH and slot containing NACK feedback may be pre-determined or configured. Alternatively, or in addition, different random access preambles may have different uplink resources to feedback NACK.

It is noted that embodiments described with reference to FIGS. 2-8 may be implemented separately. Alternatively, embodiments s described with reference to FIGS. 2-8 may be implemented in any proper combinations.

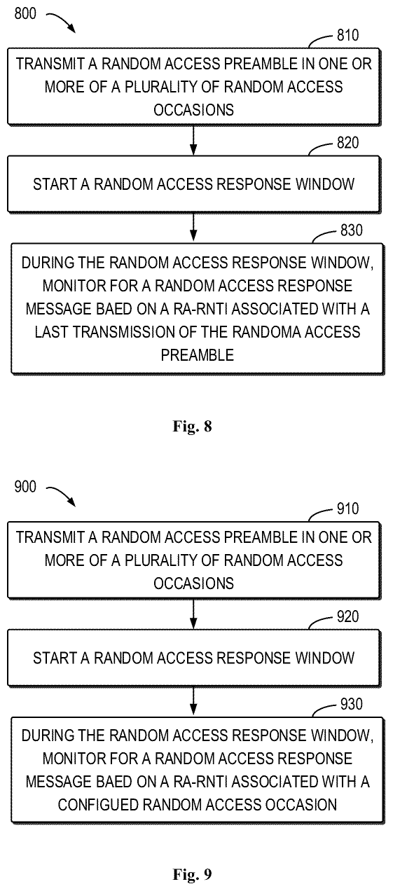

FIG. 8 shows a flowchart of an example method 800 in accordance with an embodiment of the present disclosure. The method 800 can be implemented at any suitable terminal devices. Only for the purpose of illustrations, the method 800 can be implemented at a terminal device 110 as shown in FIG. 1.

At block 810, the terminal device 110 transmits to the network device 120 a random access preamble in one or more of a plurality of random access occasions.

At block 820, the terminal device 110 starts a random access response window at a first monitoring occasion from an end of a last transmission of the random access preamble.

At block 830, during the random access response window, the terminal device 110 monitors for a random access response message based on a random access-radio network temporary identifier (RA-RNTI) associated with the last transmission of the random access preamble. In some embodiments, the RA-RNTI may be determined based on a first index and a second index. The first index may be an index of a first symbol of the last transmission of the random access preamble. The second index may be an index of a first slot of the last transmission of the random access preamble in a system frame.

FIG. 9 shows a flowchart of an example method 900 in accordance with an embodiment of the present disclosure. The method 900 can be implemented at any suitable terminal devices. Only for the purpose of illustrations, the method 900 can be implemented at a terminal device 110 as shown in FIG. 1.

At block 910, the terminal device 110 transmits to the network device 120 a random access preamble in one or more of a plurality of random access occasions.

At block 920, the terminal device 110 starts a random access response window at a first monitoring occasion from an end of a configured random access occasion in the one or more random access occasions.

At block 930, during the random access response window, the terminal device 110 monitors for a random access response message based on a random access-radio network temporary identifier (RA-RNTI).

In some embodiments, the configured random access occasion may be a first random access occasion in the one or more random access occasions. In this case, the terminal device 110 may determine the RA-RNTI based on a first index and a second index. The first index may be an index of a first symbol of the first random access occasion. The second index may be an index of a first slot of the first random access occasion in a system frame.

In some embodiments, a length of the random access response window may exceed a threshold length. In some embodiments, the terminal device 110 may receive, from the network device 120, downlink control information comprising an indication for stopping the monitoring of the random access response message. In some embodiments, the terminal device 110 may determine the configured random access occasion based on the number of transmissions of the random access preamble.

In some embodiments, the terminal device 110 may detect a downlink control information (DCI) format scrambled by the RA-RNTI. The terminal device 110 may determine that a first set of least significant bits (LSBs) of a first system frame number (SFN) in the DCI format are same as a second set of LSBs of a second SFN of a last transmission of the random access preamble. The terminal device 110 may receive a transport block on a physical downlink shared channel (PDSCH) within the random access response window. The terminal device 110 may transmit the transport block to a layer which is higher than a physical layer of the terminal device.

In some embodiments, the terminal device 110 may detect detecting a downlink control information (DCI) format scrambled by the RA-RNTI. The terminal device 110 may determine that a first set of least significant bits (LSBs) of a first system frame number (SFN) in the DCI format are same as a second set of LSBs of a second SFN of a first transmission of the random access preamble. The terminal device 110 may receive a transport block on a physical downlink shared channel (PDSCH) within the random access response window. The terminal device 110 may transmit the transport block to a layer which is higher than a physical layer of the terminal device. In this case, in some embodiments, the terminal device 110 may determine the RA-RNTI based on the first transmission of the random access preamble.

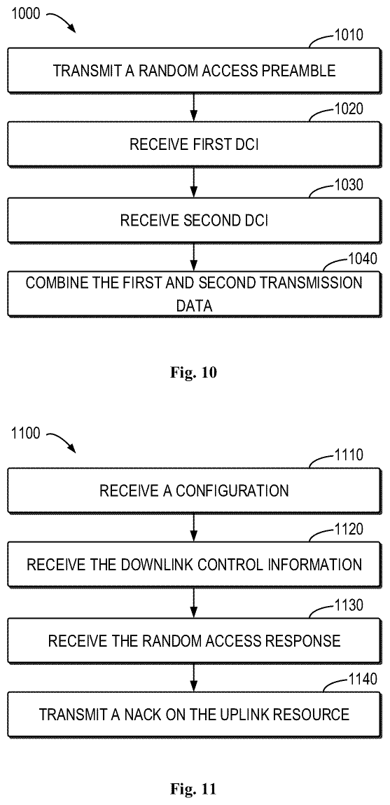

FIG. 10 shows a flowchart of an example method 1000 in accordance with an embodiment of the present disclosure. The method 1000 can be implemented at any suitable terminal devices. Only for the purpose of illustrations, the method 1000 can be implemented at a terminal device 110 as shown in FIG. 1.

At block 1010, the terminal device 110 transmits, to the network device 120, a random access preamble.

At block 1020, the terminal device 110 receives, from the network device 120, first downlink control information (DCI) scrambled with a random access-radio network temporary identifier (RA-RNTI) in a random access response window. The first DCI comprises a first indication and schedules a first data transmission on a physical downlink shared channel (PDSCH).

At block 1030, the terminal device 110 receives, from the network device, second DCI scrambled with the RA-RNTI in the random access response window. The second DCI comprises a second indication and schedules a second data transmission on the PDSCH.

At block 1040, if the first and second indications are same, the terminal device 110 combines the first data transmission and the second data transmission.

FIG. 11 shows a flowchart of an example method 1100 in accordance with an embodiment of the present disclosure. The method 1100 can be implemented at any suitable network devices. Only for the purpose of illustrations, the method 1100 can be implemented at a terminal device 110 as shown in FIG. 1.

At block 1110, the terminal device 110 receives, from the network device 120, a configuration indicating an uplink resource for a feedback of a data transmission on a physical downlink shared channel (PDSCH) associated with a random access response. In some embodiments, different random access preambles may have different uplink resources to feedback NACK.

At block 1120, the terminal device 110 receives, from the network device 120, downlink control information which is scrambled with a random access-radio network temporary identifier (RA-RNTI) and schedules the PDSCH. At block 1130, the terminal device 110 receives, from the network device 120, a random access response on the PDSCH. In some embodiments, a time length between a first slot in which the downlink control information is received and a second slot in which the NACK is transmitted may be pre-determined or configured. In some embodiments, a time length between a first slot in which the PDSCH containing RAR is received and a second slot in which the NACK is transmitted may be pre-determined or configured.

At block 1140, if the terminal device 110 fails to decode the random access response, the terminal device 110 transmits, to the network device 120, a non-acknowledgment (NACK) on the uplink resource.

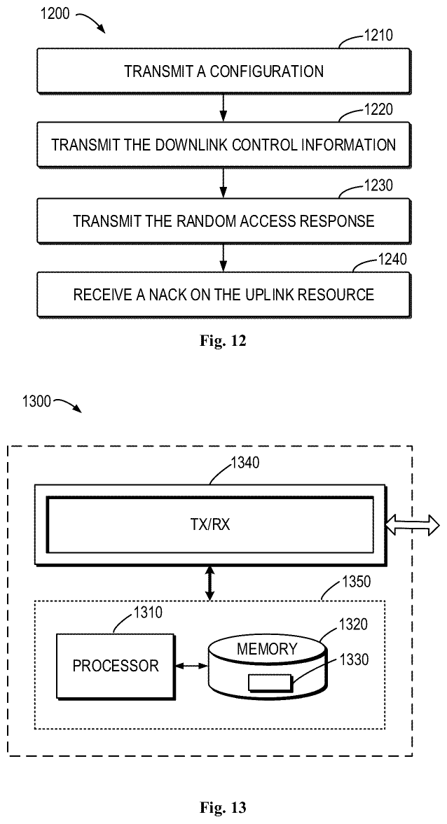

FIG. 12 shows a flowchart of an example method 1200 in accordance with an embodiment of the present disclosure. The method 1200 can be implemented at any suitable terminal devices. Only for the purpose of illustrations, the method 1200 can be implemented at a network device 120 as shown in FIG. 1.

At block 1210, the network device 120 transmits, to the terminal device 110, a configuration indicating an uplink resource for a feedback of a random access response on a physical downlink shared channel (PDSCH) associated with a random access response. In some embodiments, different random access preambles may have different uplink resources to feedback NACK.

At block 1220, the network device 120 transmits, to the terminal device 110, downlink control information which is scrambled with a random access-radio network temporary identifier (RA-RNTI) and schedules the PDSCH. At block 1230, the network device transmits, to the terminal device 110, the random access response on the PDSCH. In some embodiments, a time length between a first slot in which the downlink control information is transmitted and a second slot in which the NACK is received may be pre-determined or configured. In some embodiments, a time length between a first slot in which the PDSCH containing RAR is received and a second slot in which the NACK is transmitted may be pre-determined or configured.

At block 1140, if the terminal device 110 fails to decode the random access response on the PDSCH, the network device 120 receives, from the terminal device 110, a non-acknowledgment (NACK) on the uplink resource.

FIG. 13 is a simplified block diagram of a device 1300 that is suitable for implementing embodiments of the present disclosure. The device 1300 can be considered as a further example implementation of the terminal device 110 or the network device 120 as shown in FIG. 1. Accordingly, the device 1300 can be implemented at or as at least a part of the terminal device 110 or the network device 120.

As shown, the device 1300 includes a processor 1310, a memory 1320 coupled to the processor 1310, a suitable transmitter (TX)/receiver (RX) 1340 coupled to the processor 1310, and a communication interface coupled to the TX/RX 1340. The memory 1310 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1330 is assumed to include program instructions that, when executed by the associated processor 1310, enable the device 1300 to operate in accordance with the embodiments of the present disclosure, as discussed herein with reference to FIGS. 1 to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

In some embodiments, a terminal device comprises a circuitry configured to perform: transmitting, to a network device, a random access preamble in one or more of a plurality of random access occasions; starting a random access response window at a first monitoring occasion from an end of a last transmission of the random access preamble; and during the random access response window, monitoring for a random access response message based on a random access-radio network temporary identifier (RA-RNTI) associated with the last transmission of the random access preamble.

In some embodiments, the RA-RNTI is determined based on a first index and a second index, wherein the first index is an index of a first symbol of the last transmission of the random access preamble, and the second index is an index of a first slot of the last transmission of the random access preamble in a system frame.

In some embodiments, a terminal device comprises a circuitry configured to perform: transmitting, to a network device, a random access preamble in one or more random access occasions of a plurality of random access occasions; starting a random access response window at a first monitoring occasion from an end of a configured random access occasion in the one or more random access occasions; and during the random access response window, monitoring for a random access response message based on a random access-radio network temporary identifier (RA-RNTI).

In some embodiments, the configured random access occasion is a first random access occasion in the one or more random access occasions. In some embodiments, the terminal device comprises a circuitry configured to perform: determining the RA-RNTI based on a first index and a second index, wherein the first index is an index of a first symbol of the first random access occasion, and the second index is an index of a first slot of the first random access occasion in a system frame.

In some embodiments, a length of the random access response window exceeds a threshold length.

In some embodiments, the terminal device comprises a circuitry configured to perform: receiving, from the network device, downlink control information comprising an indication for stopping the monitoring of the random access response message.

In some embodiments, the terminal device comprises a circuitry configured to perform: determining the configured random access occasion based on the number of transmissions of the random access preamble.

In some embodiments, the terminal device comprises a circuitry configured to perform: detecting a downlink control information (DCI) format scrambled by the RA-RNTI; determining that a first set of least significant bits (LSBs) of a first system frame number (SFN) in the DCI format are same as a second set of LSBs of a second SFN of a last transmission of the random access preamble; receiving a transport block on a physical downlink shared channel (PDSCH) within the random access response window; and transmitting the transport block to a layer which is higher than a physical layer of the terminal device.

In some embodiments, the terminal device comprises a circuitry configured to perform: detecting a downlink control information (DCI) format scrambled by the RA-RNTI; determining that a first set of least significant bits (LSBs) of a first system frame number (SFN) in the DCI format are same as a second set of LSBs of a second SFN of a first transmission of the random access preamble; receiving a transport block on a physical downlink shared channel (PDSCH) within the random access response window; and transmitting the transport block to a layer which is higher than a physical layer of the terminal device.

In some embodiments, the terminal device comprises a circuitry configured to perform: determining the RA-RNTI based on the first transmission of the random access preamble.

In some embodiments, a terminal device comprises a circuitry configured to perform: transmitting, to a network device, a random access preamble; receiving, from the network device, first downlink control information (DCI) scrambled with a random access-radio network temporary identifier (RA-RNTI) in a random access response window, wherein the first DCI comprises a first indication and schedules a first data transmission on a physical downlink shared channel (PDSCH); receiving, from the network device, second DCI scrambled with the RA-RNTI in the random access response window, wherein the second DCI comprises a second indication and schedules a second data transmission on the PDSCH; and in accordance with a determination that the first and second indications are same, combining the first data transmission and the second data transmission.

In some embodiments, a terminal device comprises a circuitry configured to perform: receiving, from a network device, a configuration indicating an uplink resource for a feedback of a random access response on a physical downlink shared channel (PDSCH) associated with a random access response; receiving, from the network device downlink control information which is scrambled with a random access-radio network temporary identifier (RA-RNTI) and schedules the PDSCH, ; receiving, from the network device, the random access response on the PDSCH; and in accordance with a determination that the terminal device fails to decode the random access response, transmitting, to the network device, a non-acknowledgment (NACK) on the uplink resource.

In some embodiments, a time length between a first slot in which the downlink control information is received and a second slot in which the NACK is transmitted is pre-determined or configured. In some embodiments, a time length between a first slot in which the PDSCH containing RAR is received and a second slot in which the NACK is transmitted is pre-determined or configured.

In some embodiments, different random access preambles have different uplink resources to feedback NACK.

In some embodiments, a network device comprises a circuitry configured to perform: transmitting, to a terminal device, a configuration indicating an uplink resource for a feedback of a random access response on a physical downlink shared channel (PDSCH) associated with a random access response; transmitting, to the terminal device, downlink control information which is scrambled with a random access-radio network temporary identifier (RA-RNTI) and schedules the PDSCH; transmitting, to the terminal device, the random access response on the PDSCH; and in accordance with a determination that the terminal device fails to decode the random access response, receiving, from the terminal device, a non-acknowledgment (NACK) on the uplink resource.

In some embodiments, a time length between a first slot in which the random access response is transmitted and a second slot in which the NACK is received is pre-determined or configured. In some embodiments, a time length between a first slot in which the PDSCH containing RAR is received and a second slot in which the NACK is transmitted is pre-determined or configured.

In some embodiments, different random access preambles have different uplink resources to feedback NACK.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication comprises: transmitting, at a terminal device and to a network device, a random access preamble in one or more of a plurality of random access occasions; starting a random access response window at a first monitoring occasion from an end of a last transmission of the random access preamble; and during the random access response window, monitoring for a random access response message based on a random access-radio network temporary identifier (RA-RNTI) associated with the last transmission of the random access preamble.

In some embodiments, the RA-RNTI is determined based on a first index of a first symbol of the last transmission of the random access preamble, and a second index of a first slot of the last transmission of the random access preamble in a system frame.

In some embodiments, the method comprises: transmitting, at a terminal device and to a network device, a random access preamble in one or more random access occasions of a plurality of random access occasions; starting a random access response window at a first monitoring occasion from an end of a configured random access occasion in the one or more random access occasions; and during the random access response window, monitoring for a random access response message based on a random access-radio network temporary identifier (RA-RNTI).

In some embodiments, the configured random access occasion is a first random access occasion in the one or more random access occasions. In some embodiments, the method comprises determining the RA-RNTI based on a first index of a first symbol of the first random access occasion, and a second index of a first slot of the first random access occasion in a system frame.

In some embodiments, a length of the random access response window exceeds a threshold length.

In some embodiments, the method comprises receiving, from the network device, downlink control information comprising an indication for stopping the monitoring of the random access response message.

In some embodiments, the method comprises determining the configured random access occasion based on the number of transmissions of the random access preamble.

In some embodiments, the method comprises detecting a downlink control information (DCI) format scrambled by the RA-RNTI; determining that a first set of least significant bits (LSBs) of a first system frame number (SFN) in the DCI format are same as a second set of LSBs of a second SFN of a last transmission of the random access preamble; receiving a transport block on a physical downlink shared channel (PDSCH) within the random access response window; and transmitting the transport block to a layer which is higher than a physical layer of the terminal device.

In some embodiments, the method comprises detecting a downlink control information (DCI) format scrambled by the RA-RNTI; determining that a first set of least significant bits (LSBs) of a first system frame number (SFN) in the DCI format are same as a second set of LSBs of a second SFN of a first transmission of the random access preamble; receiving a transport block on a physical downlink shared channel (PDSCH) within the random access response window; and transmitting the transport block to a layer which is higher than a physical layer of the terminal device.

In some embodiments, the method comprises determining the RA-RNTI based on the first transmission of the random access preamble.

In some embodiments, a method of communication comprises: transmitting, at a terminal device and to a network device, a random access preamble; receiving, from the network device, first downlink control information (DCI) scrambled with a random access-radio network temporary identifier (RA-RNTI) in a random access response window, wherein the first DCI comprises a first indication and schedules a first data transmission on a physical downlink shared channel (PDSCH); receiving, from the network device, second DCI scrambled with the RA-RNTI in the random access response window, wherein the second DCI comprises a second indication and schedules a second data transmission on the PDSCH; and in accordance with a determination that the first and second indications are same, combining the first data transmission and the second data transmission.

In some embodiments, the method comprises receiving, at a terminal device and from a network device, a configuration indicating an uplink resource for a feedback of a random access response on a physical downlink shared channel (PDSCH) associated with a random access response; receiving, from the network device, downlink control information which is scrambled with a random access-radio network temporary identifier (RA-RNTI) and schedules the PDSCH; receiving, from the network device, the random access response on the PDSCH; and in accordance with a determination that the terminal device fails to decode the random access response, transmitting, to the network device, a non-acknowledgment (NACK) on the uplink resource.

In some embodiments, a time length between a first slot in which the downlink control information is received and a second slot in which the NACK is transmitted is pre-determined or configured. In some embodiments, a time length between a first slot in which the PDSCH containing RAR is received and a second slot in which the NACK is transmitted is pre-determined or configured.

In some embodiments, different random access preambles have different uplink resources to feedback NACK.

In another solution, a device of communication comprises: a processor configured to cause the device to perform any of the methods above.

In one solution, a method communication comprises transmitting, at a network device and to a terminal device, a configuration indicating an uplink resource for a feedback of a random access response on a physical downlink shared channel (PDSCH) associated with a random access response; transmitting, to the terminal device, downlink control information which is scrambled with a random access-radio network temporary identifier (RA-RNTI) and schedules the PDSCH; transmitting, to the terminal device, the random access response on the PDSCH; and in accordance with a determination that the terminal device fails to decode the random access response on the PDSCH, receiving, from the terminal device, a non-acknowledgment (NACK) on the uplink resource.

In some embodiments, a time length between a first slot in which the downlink control information is transmitted and a second slot in which the NACK is received is pre-determined or configured. In some embodiments, a time length between a first slot in which the PDSCH containing RAR is received and a second slot in which the NACK is transmitted is pre-determined or configured.

In some embodiments, different random access preambles have different uplink resources to feedback NACK.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

I/We claim:

1. A communication method, comprising:
transmitting, at a terminal device and to a network device, a random access preamble in one or more of a plurality of random access occasions;
starting a random access response window at a first monitoring occasion from an end of a last transmission of the random access preamble; and
during the random access response window, monitoring for a random access response message based on a random access-radio network temporary identifier (RA-RNTI) associated with the last transmission of the random access preamble.

2. The method of claim 1, wherein the RA-RNTI is determined based on a first index and a second index, wherein the first index is an index of a first symbol of the last transmission of the random access preamble, and the second index is an index of a first slot of the last transmission of the random access preamble in a system frame.

3. A communication method, comprising:
transmitting, at a terminal device and to a network device, a random access preamble in one or more random access occasions of a plurality of random access occasions;
starting a random access response window at a first monitoring occasion from an end of a configured random access occasion in the one or more random access occasions; and
during the random access response window, monitoring for a random access response message based on a random access-radio network temporary identifier (RA-RNTI).

4. The method of claim 3, wherein the configured random access occasion is a first random access occasion in the one or more random access occasions, and
wherein the method further comprising:
determining the RA-RNTI based on a first index and a second index, wherein the first index is an index of a first symbol of the first random access occasion, and the second index is an index of a first slot of the first random access occasion in a system frame.

5. The method of claim 4, wherein a length of the random access response window exceeds a threshold length.

6. The method of claim 4, further comprising:
receiving, from the network device, downlink control information comprising an indication for stopping the monitoring of the random access response message.

7. The method of claim 3, further comprising:
determining the configured random access occasion based on the number of transmissions of the random access preamble.

8. The method of claim 3, further comprising:
detecting a downlink control information (DCI) format scrambled by the RA-RNTI;
determining that a first set of least significant bits (LSBs) of a first system frame number (SFN) in the DCI format are same as a second set of LSBs of a second SFN of a last transmission of the random access preamble;
receiving a transport block on a physical downlink shared channel (PDSCH) within the random access response window; and
transmitting the transport block to a layer which is higher than a physical layer of the terminal device.

9. The method of claim 3, further comprising:
detecting a downlink control information (DCI) format scrambled by the RA-RNTI;
determining that a first set of least significant bits (LSBs) of a first system frame number (SFN) in the DCI format are same as a second set of LSBs of a second SFN of a first transmission of the random access preamble;
receiving a transport block on a physical downlink shared channel (PDSCH) within the random access response window; and
transmitting the transport block to a layer which is higher than a physical layer of the terminal device.

10. The method of claim 9, further comprising:
determining the RA-RNTI based on the first transmission of the random access preamble.

11. A communication method, comprising:
transmitting, at a terminal device and to a network device, a random access preamble;
receiving, from the network device, first downlink control information (DCI) scrambled with a random access-radio network temporary identifier (RA-RNTI) in a random access response window, wherein the first DCI comprises a first indication and schedules a first data transmission on a physical downlink shared channel (PDSCH);
receiving, from the network device, second DCI scrambled with the RA-RNTI in the random access response window, wherein the second DCI comprises a second indication and schedules a second data transmission on the PDSCH; and
in accordance with a determination that the first and second indications are same, combining the first data transmission and the second data transmission.

12. A communication method, comprising:
receiving, at a terminal device and from a network device, a configuration indicating an uplink resource for a feedback of a random access response on a physical downlink shared channel (PDSCH);
receiving, from the network device, downlink control information which is scrambled with a random access-radio network temporary identifier (RA-RNTI) and schedules the PDSCH;
receiving, from the network device, the random access response on the PDSCH; and
in accordance with a determination that the terminal device fails to decode the random access response, transmitting, to the network device, a non-acknowledgment (NACK) on the uplink resource.

13. The method of claim 12, wherein a time length between a first slot in which the downlink control information is received and a second slot in which the NACK is transmitted is pre-determined or configured.

14. The method of claim 12, wherein different random access preambles have different uplink resources to feedback NACK.

15. A communication method, comprising:
transmitting, at a network device and to a terminal device, a configuration indicating an uplink resource for a feedback of a random access response on a physical downlink shared channel (PDSCH);
transmitting, to the terminal device, downlink control information which is scrambled with a random access-radio network temporary identifier (RA-RNTI) and schedules the PDSCH;
transmitting, to the terminal device, the random access response on the PDSCH; and
in accordance with a determination that the terminal device fails to decode the random access response on the PDSCH, receiving, from the terminal device, a non-acknowledgment (NACK) on the uplink resource.

16. The method of claim 15, wherein a time length between a first slot in which the downlink control information is transmitted and a second slot in which the NACK is received is pre-determined or configured.

17. The method of claim 15, wherein different random access preambles have different uplink resources to feedback NACK.

18. A terminal device comprising:
a processor; and
a memory coupled to the processor and storing instructions thereon, the instructions, when executed by the processor, causing the terminal device to perform acts comprising the method according to any of claims 1-2, any of claims 3-10, or claim 11, or any of claims 12-14.

19. A network device comprising:
a processor; and
a memory coupled to the processor and storing instructions thereon, the instructions, when executed by the processor, causing the network device to perform acts comprising the method according to any of claims 15-17.

20. A computer readable medium having instructions stored thereon, the instructions, when executed on at least one processor, causing the at least one processor to perform the method according to any of claims 1-2, or any of claims 3-10, or any of claims 12-14, or any of claims 15-17.
